(19) United States
(12) Patent Application Publication
(10) Pub. No.: US 2008/0084277 A1
(43) Pub. Date: Apr. 10, 2008

(54) RFID COMMUNICATION SYSTEM, RFID COMMUNICATION DEVICE AND RFID COMMUNICATION METHOD

(75) Inventor: Hideaki Korekoda, Kanagawa (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/861,552

(22) Filed: Sep. 26, 2007

(30) Foreign Application Priority Data
Sep. 27, 2006 (JP) 2006-263198

(51) Int. Cl. H04Q 5/22

(52) U.S. Cl. 340/10.1

(57) ABSTRACT

An RFID communication system includes a communication parameter setting section configured to modifiably set communication parameters in performing wireless communication; a receiving state determining section configured to, in the case where a signal for causing an RFID provided with a wireless communication function to wirelessly reply has been wirelessly transmitted with respect to the above described RFID by using the previously set communication parameters, determine a state of receiving a reply signal wirelessly replied from the above described RFID; and a control section configured to, if a determination result by the above described receiving state determining section does not satisfy a predetermined condition, control to modify the communication parameters modifiable by the above described communication parameter setting section.

### CROSS-REFERENCE TO RELATED APPLICATION

This application is based upon and claims the benefit of priority from the prior Japanese Patent Application No. 2006-263198 filed on Sep. 27, 2006; the entire contents of which are incorporated herein by reference.

### BACKGROUND OF THE INVENTION

1. Field of the Invention

The present invention relates to an RFID communication system, an RFID communication device and an RFID communication method using an RFID.

2. Description of the Related Art

Currently, an RFID communication system provided with an RFID (Radio Frequency Identification) and an RFID communication device (or a read/write device, hereinafter abbreviated as R/W) configured to perform wireless communication and perform read/write of information has been internationally standardized in ISO 14443, ISO 18000 and the like, in which magnetic field intensity of the communication by the R/W, a measuring method thereof and the like have been prescribed.

These standardizations aim at enabling the R/W and the RFID compliant with the same standard to perform a communication operation.

However, in fact, a communication failure may occur depending on a combination of the RFID and the R/W.

Particularly, recently, the number of kinds of the RFID has increased, and such a situation has been significant. Moreover, it is typically considered that this situation can be addressed with a design based on a most incompatible RFID. However, in fact, parameters in the RFID may contradict one another, and the RFID may not be operable with a single setting.

Moreover, even with respect to the same RFID, there is a failure in which a communication error may occur depending on a communication distance.

An antecedent example of Japanese Patent Laid-Open No. 2005-260521 discloses a device configured to rapidly and easily set a communicable state, regardless of kinds of circuit elements of an RFID to be communicated with.

The device detects tag attribute parameters or communication parameters of the circuit elements of the RFID provided in a cartridge provided with the circuit elements of the RFID in a state before being separated and used as an individual RFID.

Then, when the device transmits a signal which accesses an antenna on the part of the RFID in order to access an IC circuit section configured to store RFID information on the circuit elements of the RFID, the device controls to match the detected tag attribute parameters or communication parameters of the circuit elements of the RFID.

The antecedent example assumes that, when wirelessly accessing the circuit elements of the RFID, the tag attribute parameters or the communication parameters can be obtained based on an identifier provided in the cartridge, by detection means using an optical sensor and the like.

Moreover, the antecedent example does not consider that the communication error may occur depending on variation in characteristics of the individual RFID or the communication distance in transmitting a signal which performs wireless access.

Therefore, the antecedent example cannot be applied to the case of the RFID having unknown communication parameters and the like in the state of being used as the individual RFID as described above, variation in the RFIDs, and an RFID affected by the communication distance.

### SUMMARY OF THE INVENTION

An RFID communication system according to an embodiment of the present invention includes a communication parameter setting section configured to modifiably set communication parameters related to communication characteristics in performing wireless communication; a receiving state determining section configured to, in the case where a signal for causing an RFID provided with a wireless communication function to wirelessly reply has been wirelessly transmitted with respect to the above described RFID by using previously set communication parameters, determine a state of receiving a reply signal wirelessly replied from the above described RFID; and a control section configured to, if a determination result by the above described receiving state determining section does not satisfy a predetermined condition, control to modify the communication parameters modifiable by the above described communication parameter setting section.

An RFID communication device according to an embodiment of the present invention includes a wireless communication section configured to perform wireless communication with an RFID provided with a wireless communication function; a communication parameter setting section configured to modifiably set communication parameters related to communication characteristics in performing the wireless communication by the above described wireless communication section; a receiving state determining section configured to wirelessly transmit a signal for causing the above described RFID to wirelessly reply, from the above described wireless communication section, and determine a state of receiving a reply signal wirelessly replied from the above described RFID; and a control section configured to, if a result of determining the receiving state by the above described receiving state determining section does not satisfy a predetermined condition, control to modify the communication parameters used for the above described wireless transmission and perform the wireless transmission.

An RFID communication method according to an embodiment of the present invention includes, in the case where a signal for causing an RFID provided with a wireless communication function to wirelessly reply has been wirelessly transmitted with respect to the above described RFID by using previously set communication parameters related to communication characteristics, determining a state of receiving a reply signal wirelessly replied from the above described RFID; and if a result of determining the above described receiving state does not satisfy a predetermined condition, controlling to modify the above described communication parameters and perform the wireless transmission.

### BRIEF DESCRIPTION OF THE DRAWINGS

FIG. 1 is a block diagram showing a configuration of an RFID communication system according to a first embodiment of the present invention;

FIG. 2 is a block diagram showing an internal configuration example of an RFID;

FIG. 3 is a circuit diagram showing an example of an RFID read/write device;

FIG. 4 is a flowchart showing contents of an operation of performing communication with the RFID by the RFID read/write device;

FIG. 5 is a circuit diagram showing an example of the RFID read/write device according to a second embodiment of the present invention;

FIG. 6 is a flowchart showing a part of the contents of the operation of performing the communication with the RFID by the RFID read/write device according to the second embodiment;

FIG. 7 is a block diagram showing an internal configuration example of the RFID according to a third embodiment of the present invention; and

FIG. 8 is a flowchart showing a part of the contents of the operation of performing the communication with the RFID read/write device and the RFID according to the third embodiment.

### DETAILED DESCRIPTION OF THE PREFERRED EMBODIMENTS

Embodiments of the present invention will be described below with reference to the drawings.

### First Embodiment

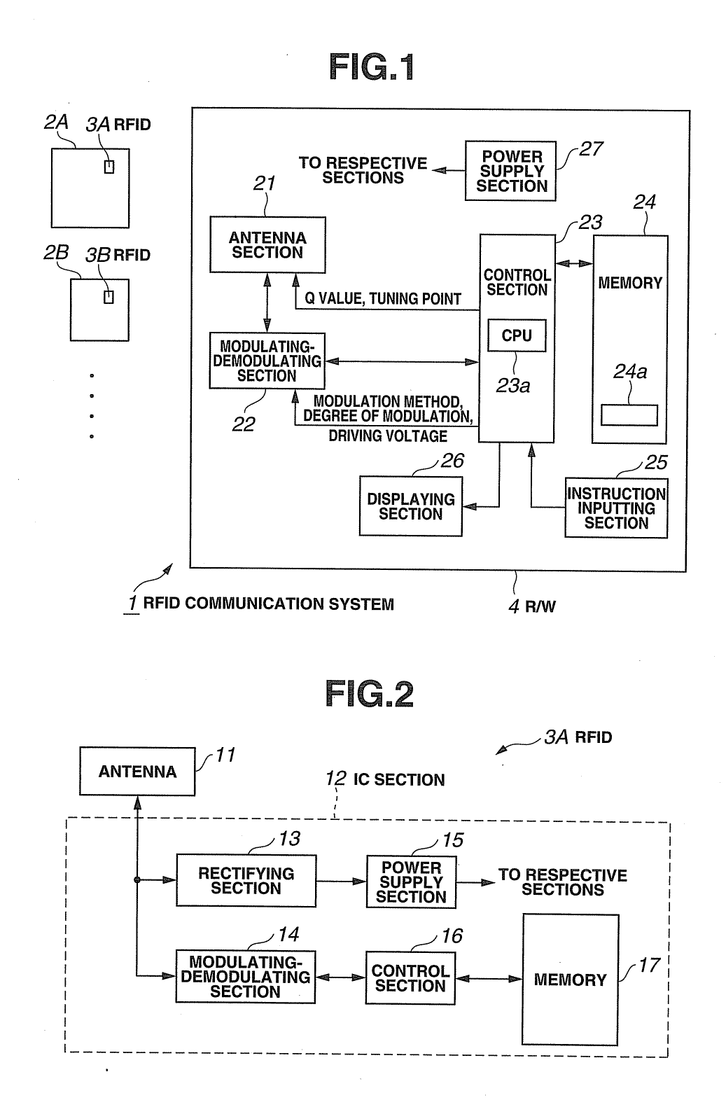

FIG. 1 shows an RFID communication system 1 according to a first embodiment of the present invention.

This RFID communication system 1 is provided with RFIDs (Radio Frequency Identifications) 3A, 3B, . . . which are attached to objects such as electric equipments and the like 2A, 2B, and provided with a wireless communication function, and an RFID communication device (or a read/write device) 4 provided with a wireless communication function configured to perform wireless communication with an arbitrary RFID 3I (I=A, B, . . . ) in these RFIDs 3A, 3B, . . . .

The RFID read/write device (hereinafter referred to as R/W) 4 is provided with at least a read function configured to read information on the RFID 3I, and may also be provided with a write function configured to write the information.

FIG. 2 shows an internal configuration of, for example, the RFID 3A. It should be noted that other RFIDs 3B and the like have almost the same basic configuration. The RFID 3A has an antenna 11 configured to perform the wireless communication with the R/W 4, and an integrated circuit section (IC section) 12 connected to the antenna 11.

The IC section 12 has a rectifying section 13 and a modulating-demodulating section 14 connected to the antenna 11, a power supply section 15 connected to the rectifying section 13, a control section 16 connected to the modulating-demodulating section 14, and a memory 17 connected to this control section 16.

The rectifying section 13 rectifies a carrier received by the antenna 11 and supplies the carrier to the power supply section 15, and the power supply section 15 accumulates rectified electric energy and generates power supply configured to operate the control section 16 and the like. It should be noted that FIG. 2 shows an example of the RFID 3A of passive type, and the RFID 3A of active type does not require the rectifying section 13 and employs a battery as the power supply section 15.

Under the control of the control section 16, the modulating-demodulating section (or transmitting-receiving section) 14 generates a modulated signal and transmits the modulated signal via the antenna 11 when the transmission is performed, and the modulating-demodulating section 14 demodulates a received modulated signal and supplies the demodulated signal to the control section 16 when the reception is performed. The antenna 11 and the modulating-demodulating section 14 form wireless communication means configured to perform the wireless communication with the R/W 4.

The control section 16 interprets a command according to the signal received via the modulating-demodulating section 14, with reference to information stored in the memory 17, and performs a corresponding control, transmits a response signal corresponding to the received signal, or the like.

Moreover, the memory 17 stores information on the command corresponding to the transmitted signal, or stores transmitted information.

On the other hand, as shown in FIG. 1, the R/W 4 has an antenna section 21 configured to perform the wireless communication with the antenna 11 on the part of the RFID 3I, and a modulating-demodulating section 22 configured to modulate and transmit a signal from this antenna section 21, and also demodulate a signal received by the antenna section 21 and output the signal to a control section 23. The antenna section 21 and the modulating-demodulating section 22 form wireless communication means configured to perform the wireless communication with the RFID 3I.

Moreover, the R/W 4 has the control section 23 configured to control the antenna section 21 and the modulating-demodulating section 22, a memory 24 configured to store data on commands to be transmitted and the like, an instruction inputting section 25 configured to input an instruction by a user, a displaying section 26 configured to display information for which the instruction has been inputted, a receiving state and the like, and a power supply section 27 configured to supply power to the respective sections such as the modulating-demodulating section 22.

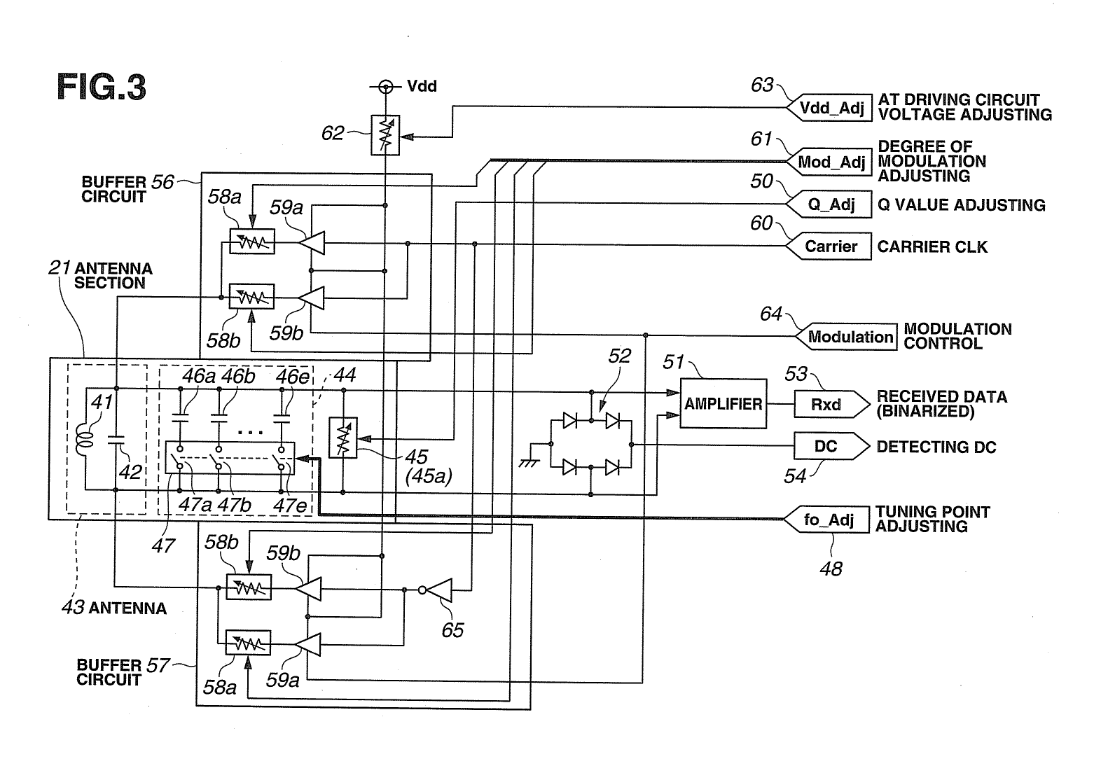

As will be described below in FIG. 3, the antenna section 21 has a configuration in which communication parameters related to or affecting communication characteristics such as a Q value, a tuning point (tuning frequency) and the like can be modified and set.

Moreover, the modulating-demodulating section 22 also has a configuration in which the communication parameters such as a modulation method, a degree of modulation and the like can be modified and set, and can also modify and set a transmission output with a driving voltage (driving output).

In other words, the R/W 4 is provided with a configuration in which the communication parameters configured to determine communication conditions affecting the communication characteristics in performing the communication with the RFID 3I can be modified and set, that is, a function of communication parameter setting means.

It should be noted that the respective communication parameters such as the Q value have their variable ranges set so as to include the case of normal characteristics set in various RFID 3I.

The control section 23 controls to modify and set the communication parameters in performing the communication with the RFID 3I, that is, the communication conditions.

Therefore, the memory 24 stores control program data 24a for performing an operation of controlling to modify and set the communication parameters by a CPU 23a configuring the control section 23. It should be noted that the memory 24 also stores data such as commands configured to perform various instructions with respect to the RFID 3I. Moreover, this data also includes a command configured to request a reply signal with respect to the RFID 3I.

When the power of the R/W 4 is turned on, the CPU 23a reads this control program data 24a and becomes in an operating state of performing the control.

Then, when the user inputs an instruction to perform the communication with the RFID 3I, from the instruction inputting section 25, the CPU 23a cyclicly modifies and sets the communication parameters, and performs the control of wirelessly transmitting a reply request transmitting signal for requesting the reply signal with respect to the RFID 3I.

Moreover, on this occasion, the CPU 23a determines whether or not a state of receiving the reply signal replied from the RFID 3I at the R/W 4 satisfies a predetermined condition of whether or not the reply signal has been able to be normally received, according to the demodulated signal from the modulating-demodulating section 22. In other words, the CPU 23a forms receiving state determining means.

Then, if the reply signal has been able to be normally received (demodulated) (if the predetermined condition is satisfied), the CPU 23a maintains the communication parameters, and if the reply signal has not been able to be normally received (if the predetermined condition is not satisfied), the CPU 23a controls to modify the communication parameters.

In other words, the CPU 23a forms control means configured to perform a control of whether or not to modify the communication parameters depending on the state of receiving the reply signal.

More specifically, the CPU 23a controls to modify the communication parameters if the state of receiving the reply signal does not satisfy the predetermined condition.

Furthermore, the CPU 23a controls to sequentially modify the communication parameters if the state of receiving the reply signal does not satisfy the predetermined condition.

In this way, the present embodiment has a configuration in which a communicable state can be automatically set by modifying and setting the communication parameters and repeatedly performing the wireless communication, even if the kind or the like of the RFID 3I is different and the standard of the RFID 31 to be communicated with is unknown.

FIG. 3 shows a circuit configuration of the periphery of the antenna section 21 in the R/W 4, including the antenna section 21. FIG. 3 shows an example of a circuit configuration in the case of accommodating the RFID 3I of a short range, weak wireless standard.

The antenna section 21 has an antenna 43 consisting of a parallel connection circuit of a coil 41 and a condenser 42, and for example, a tuning point adjusting circuit 44 and a Q value adjusting circuit 45 are connected in parallel to this antenna 43.

The tuning point adjusting circuit 44 is configured with a condenser 46a and a switch 47a, a condenser 46b and a switch 47b, . . . , a condenser 46e and a switch 47e, which are connected in parallel to the condenser 42. The condensers 46a, 46b, . . . , 46e may have the same or different capacities, respectively.

The respective switches 47a, 47b, . . . , 47e configuring a switch circuit 47 are turned ON/OFF, according to a binary tuning point adjusting signal applied via a signal line connected to a tuning point adjusting terminal (fo_Adj in FIG. 3) 48 of the control section 23.

The control section 23 can adjust a tuning point of the antenna 43 by controlling the number of switches to be turned on, with the tuning point adjusting signal.

Moreover, the Q value adjusting circuit 45 is formed with, for example, a variable resistor 45a such as an electronic volume having an electrically modifiable resistance value.

The resistance value of this variable resistor 45a is variably controlled according to a multivalued Q value adjusting signal applied via a signal line connected to a Q value adjusting terminal (Q_Adj in FIG. 3) 50 of the control section 23.

In other words, the control section 23 can adjust a Q value of the antenna 43 by varying the resistance value parallel to the antenna 43 with the Q value adjusting signal.

Moreover, both ends of the antenna 43 are connected to an amplifier 51 and a detecting diode bridge 52 configuring the modulating-demodulating section 22.

The amplifier 51 amplifies a signal induced by the antenna 43 and outputs the signal from a received data terminal 53 to a demodulating section within the modulating-demodulating section 22. The modulating-demodulating section 22 generates binarized received data from the signal inputted from the received data terminal 53 and outputs the data to the control section 23.

The detecting diode bridge 52 detects the signal induced by the antenna 43 in a full-wave method, and outputs the detected signal from a detecting terminal (DC in FIG. 3) 54 to the control section 23.

Moreover, buffer circuits 56 and 57 configuring the modulating-demodulating section 22 are connected to one terminal and the other terminal in the antenna 43, respectively.

In the buffer circuit 56, a parallel circuit of a variable resistor 58a and a buffer 59a as well as a variable resistor 58b and a buffer 59b is connected to the one terminal in the antenna 43.

Buffers 59a and 59b are connected to a carrier terminal (Carrier in FIG. 3) 60 in the modulating-demodulating section 22, and a carrier clock (carrier CLK in FIG. 3) is inputted from this carrier terminal 60 to the buffers 59a and 59b.

Resistance values of the variable resistors 58a and 58b are variably controlled according to a multivalued degree of modulation adjusting signal applied via a signal line connected to a degree of modulation adjusting terminal (Mod_Adj in FIG. 3) 61 of the control section 23.

The control section 23 can adjust the degree of modulation when the carrier clock is outputted to the antenna 43, with the degree of modulation adjusting signal.

Moreover, power supply terminals on the respective positive electrodes of the buffers 59a and 59b are connected to an antenna driving power supply terminal Vdd configured to drive the antenna 43 (and the modulating-demodulating section 22) via a variable resistor 62.

A resistance value of the variable resistor 62 is variably controlled according to a multivalued antenna driving circuit voltage adjusting signal applied via a signal line connected to an antenna driving circuit voltage adjusting terminal (Vdd Adj in FIG. 3) 63 in the control section 23.

The control section 23 can adjust a transmission signal output transmitted from the antenna 43, with the antenna driving circuit voltage adjusting signal.

Moreover, power supply terminals on the respective negative electrodes of the buffers 59a and 59b are connected to a modulating terminal (Modulation in FIG. 3) 64 in the modulating-demodulating section 22 via a signal line. The modulation can be performed in a modulation method selected from multiple modulation methods, according to a modulation control signal applied via this signal line.

Moreover, the buffer circuit 57 connected to the other terminal in the antenna 43 has a configuration of the above described buffer circuit 56 and further an inverter (inverting circuit) 65 added to the buffer circuit 56. In other words, the carrier clock from the carrier terminal 60 is applied to the buffers 59a and 59b in the buffer circuit 56, and in addition, the carrier clock from the carrier terminal 60 is inverted by the inverter 65 and applied to the buffers 59a and 59b in the buffer circuit 57.

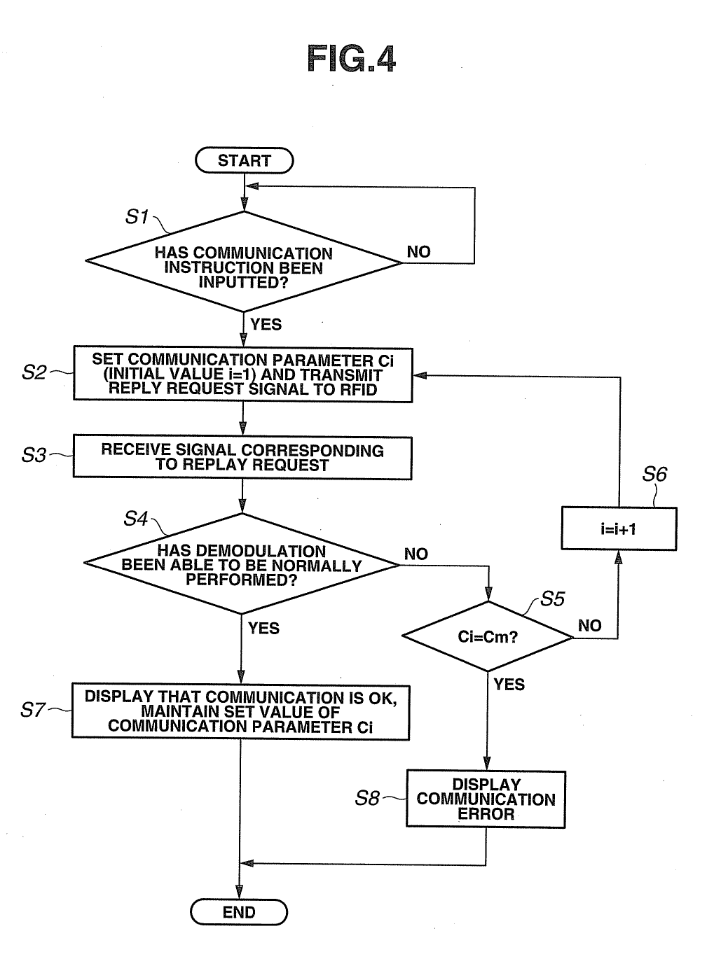

An operation of performing the communication with the RFID 3I by the R/W 4 in the RFID communication system 1 in this configuration will be described with reference to FIG. 4.

FIG. 4 shows a flowchart showing contents of the operation of performing the communication with the RFID 3I by the R/W 4.

It should be noted that all of the communication parameters such as the Q value and the tuning point are simplified and described corresponding to communication parameters Ci (i=1 to m) in FIG. 4. Here, practically, set values of multiple kinds of communication parameters are simplified and represented as Ci.

For example, if a communication parameter Qi of the Q value, a communication parameter fi of the tuning point, a communication parameter Mi of the modification method, . . . are assumed as the communication parameter Ci, Ci denotes (Qi, fi, Mi, . . . ).

Then, Ci+1 is modified so that Ci+1 is different from the communication parameter Ci in a value of one kind of communication parameter and the like, for example, such as Ci+1=(Qi+1, fi, Mi, . . . ). It should be noted that, in the case of the communication parameter such as the modification method Mi, if a subscript i is different, the modification method itself is modified.

When the power is turned on, (the CPU 23a of) the control section 23 reads the control program data 24a and becomes in a state of performing the control operation, and becomes in a state of waiting for the communication instruction inputted by the user, as shown in step S1.

When the user inputs the communication instruction, the CPU 23a sets the communication parameter Ci (initially to an initial value i=1) and transmits the reply request signal with respect to the RFID 3I (the signal may be another signal involving the reply request), as shown in step S2.

It should be noted that, also in the case where the signal which requires no replay request has been transmitted from the R/W 4, the case is not limited to the case of transmitting the reply request signal, if the RFID 3I has been set to return the reply signal whenever receiving the signal from the R/W 4. For simplicity, the case of transmitting the reply request signal will be described below.

It should be noted that, if the reply request signal is transmitted in consideration of the case where the RFID 3I is of the passive type, the carrier is preferably transmitted to the RFID 3I at a timing at least prior to the transmission of the reply request signal so that the RFID 3I can generate the power supply for the operation to accommodate the reply request signal.

Then, at the next step S3, the R/W 4 becomes in a state of receiving a signal corresponding to the reply request, from the RFID 3I. Moreover, as shown in step S4, the CPU 23a monitors the received signal via the amplifier 51 configuring (the demodulating section in) the modulating-demodulating section 22, and determines whether or not the demodulation (receiving) has been able to be normally performed.

If the demodulation has not been able to be normally performed, the CPU 23a determines whether or not the communication parameter is the last communication parameter Cm, as shown in step S5. If the communication parameter does not correspond to the last communication parameter Cm, the CPU 23a controls to modify the communication parameter to the next communication parameter as shown in step S6 (which is simplified and shown as i=i+1 in FIG. 4), and the process returns to step S2.

In other words, the communication parameter Ci is modified and a similar process is performed. If the RFID 3I has characteristics which do not deviate widely from a normal standard, the demodulation can be normally performed according to the determination process at step S4, by modifying the communication parameter and repeating the similar process as described above.

In this case, at step S7, the CPU 23a displays that the communication is OK and the like on the displaying section 26 to notify the user that the communication can be normally performed, and also controls to maintain a state of the set values of the communication parameter Ci in that state.

In this case, ID information and the like on the RFID 3I with which the communication has been able to be performed, and information on the communication parameter may be stored in the memory 24.

Then, when the communication is next performed, the CPU 23a may set the set value of the communication parameter Ci to a communication parameter C1 having the initial value 1 and perform the communication. This makes it easy to set the communicable state in a short period of time, if the communication is performed with respect to the RFID having the characteristics close to the RFID 3I with which the communication has been previously performed normally.

At step S5, if the demodulation has not been able to be normally performed even in the case where the last communication parameter Cm has been set, the CPU 23a perform a control process of displaying a communication error on the displaying section 26 at step S8, and this process is terminated.

According to the present embodiment configured to perform this operation, since the communication conditions such as the communication parameters are modified and set and the communication is performed, the setting can be automatically performed to enable the communication also with respect to the RFID 31 having different communication characteristics and the like, unless the characteristics of the wireless communication of the RFID 3I deviate widely from a standard to be satisfied.

Also, it is possible to maintain the communicable state, and smoothly read the information from the RFID 3I, write the information, update the information and the like.

In the communication between the RFID 3I and the R/W 4, incommunicable states are roughly divided into three states as follows.

1) Contents of the command from the R/W 4 have not been able to be properly received at the RFID 3I.

2) The reply from the RFID 3I has not been able to be properly received at the R/W 4.

3) A receiving level (levels of electric power and the carrier) of the RFID 3I is low. If the RFID 3I itself is not in an operating condition, these states are similar for both the RFID 3I of the passive type which uses the electric power transmitted from the R/W 4 as its own electric power, and the RFID 3I of the active type which is mounted with the battery and the like and operates with the battery and the like as the power supply.

With respect to the incommunicable states as described above, in the present embodiment, the communication parameter Ci of the R/W 4 is sequentially modified and the wireless communication is performed.

For example, in the case of 1), normally, the modification of the modulation method or the tuning point, or the modification of the driving voltage (the transmission output from the R/W 4) can eliminate the incommunicable state. Moreover, with respect to the case of 2), normally, the modification of the Q value or the tuning point and the like can eliminate the incommunicable state.

Moreover, with respect to the case of 3), similarly to the case of 1), normally, the modification of the modulation method or the tuning point, or the modification to increase the driving voltage (the transmission output from the R/W 4) can eliminate the incommunicable state.

In this way, according to the present embodiment, the setting can be automatically performed to enable the communication also with respect to the RFID 31 having different communication characteristics and the like, unless the characteristics of the wireless communication of the RFID 3I deviate widely from the standard to be satisfied.

Moreover, when the state becomes the communicable state, the user is notified of the communicable state on the displaying section 26. Therefore, since the user does not have to perform an operation of modifying and setting the communication parameters to check whether or not the communication can be performed, operability or usability can be significantly improved.

It should be noted that, in the operation example shown in FIG. 4, the R/W 4 can be applied also in the case where the kind or the like of the RFID 3I is unknown. Conversely, there is the case where the kind or the characteristics of the RFID 3I to be used are previously known from the operation side.

Even if there are multiple RFIDs 3I to be communicated with the R/W 4, the RFID which is actually used may be identified by an application and the like in the operation (for example, the case where A business uses only the RFID 3C, and the like). In that case, on the part of the R/W 4, information on the kinds or the set values and the like of the communication parameters to be used with respect to the RFID 3C has been stored in the memory 24 and the like. Then, the information is used to perform the communication as described above. In this case, since a total number of the communication parameters Ci to be modified and set can be reduced, the communicable state can be set in a shorter period of time.

It should be noted that, in the above description, although the operation example has been described in which the modification and the setting of the communication parameter Ci in the R/W 4 are performed with respect to all of the communication parameters from the communication parameter C1 having the initial value i=1 to the last communication parameter Cm, the modification and the setting of the communication parameter Ci are not limited thereto. For example, if the communication parameter Ci is modified, the communication parameter Ci may be modified in a thinning fashion.

Moreover, for example, in the instruction inputting section 25, the user may be able to appropriately set the communication parameters to be actually modified and set, in a range of the communication parameters C1 to Cm. Moreover, the order of modifying and performing the communication parameter Ci may be able to appropriately set by the user, for example, from the instruction inputting section 25.

For example, in the setting in a state of a value close to the initial value of the communication parameter Ci, the communication parameters may be set to a state where the transmission output in the case of transmitting from the R/W 4 is increased to a maximum value and the like, to examine whether or not the wireless communication with the RFID 3I can be performed.

### Second Embodiment

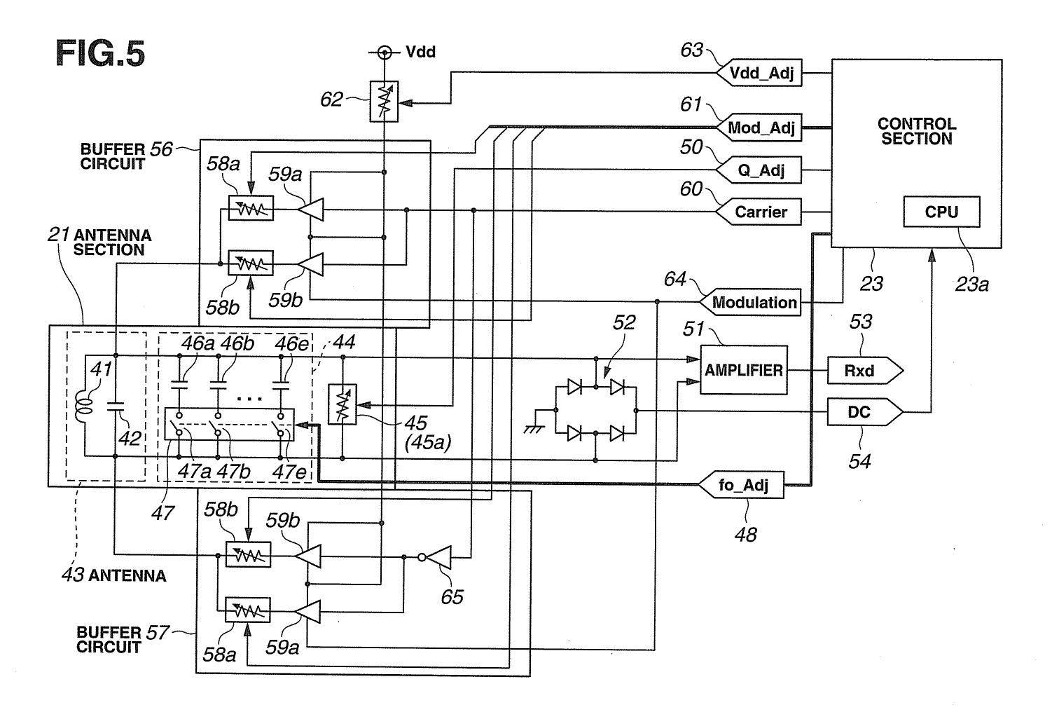

FIG. 5 shows a configuration example of a peripheral circuit around the antenna section 21 in the R/W, including the antenna section 21, according to a second embodiment of the present invention.

In the configuration shown in FIG. 5, the control section 23 is added with a function configured to control the modification and the setting of the communication parameter Ci by using a detected voltage in the case where the signal from the RFID 31 has been received by the modulating-demodulating section 22, in the R/W 4 according to the first embodiment.

If the signal from the RFID 3I is received by the R/W 4, a loaded state on the part of the R/W 4 with respect to the RFID 3I is changed depending on a communication distance with the RFID 3I, and an induced voltage or the detected voltage to be inputted to the demodulating section in the modulating-demodulating section 22 of the R/W 4 is changed.

The R/W according to the present embodiment (hereinafter denoted by the same reference numerical 4 as the R/W 4 according to the first embodiment) has previously stored data on characteristics in which the detected voltage is changed depending on the communication distance, in the memory 24 and the like.

When the communication with the RFID 3I is performed, the CPU 23a monitors a level of the detected voltage, compares the detected voltage which is actually obtained with the previously stored characteristics and the like, and controls to modify the communication parameter Ci so that the state becomes a state where the communication can be more easily performed.

For example, if the CPU 23a compares the actually obtained detected voltage with a threshold Vth which has been set corresponding to the previously stored characteristics, and if the CPU 23a determines that the detected voltage obtained in that setting state of the communication parameter Ci is too low, the CPU 23a modifies a value of a particular communication parameter, for example, by increasing the transmission output (modified output) or increasing the Q value. Then, the CPU 23a controls to increase the detected voltage to be detected.

This will be described more specifically by using FIG. 5. When the signal from the RFID 3I has been received, the detected voltage detected by the diode bridge 52 is inputted to the CPU 23a of the control section 23. Then, the CPU 23a compares the threshold Vth which has been previously stored in the memory 24, with the detected voltage, in consideration of the state of the currently set communication parameter Ci.

Then, if the CPU 23a determines that, for example, the detected voltage is too low based on the comparison, the CPU 23a controls to modify the particular communication parameter by increasing the transmission output, increasing the current Q value or the like so as to correct the detected voltage.

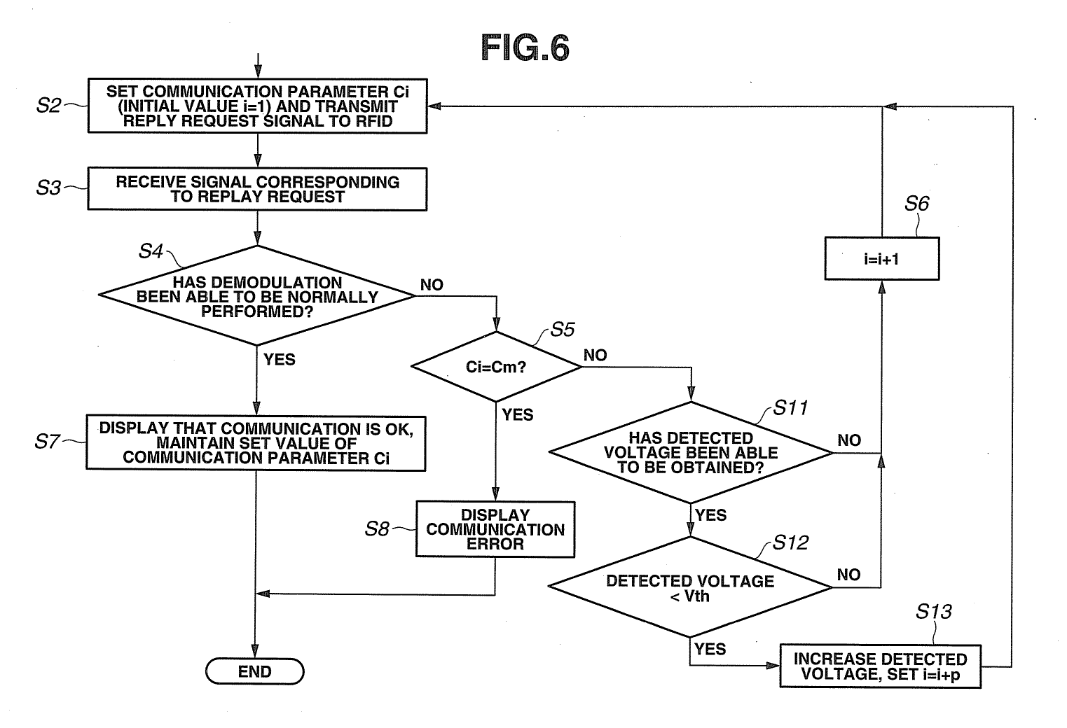

FIG. 6 is a flowchart showing a part of the contents of the operation of performing the communication with the RFID 3I by the R/W 4 according to the second embodiment.

The contents of the operation in FIG. 6 are different from those in FIG. 4 only in steps S5 and S6.

At step S5, if the current communication parameter Ci is the last communication parameter Cm, the process proceeds to step S8 similarly to the case of FIG. 4.

On the other hand, if the current communication parameter Ci does not match the last communication parameter Cm, the CPU 23a of the control section 23 determines whether or not the detected voltage can be obtained, as shown in step S11.

Then, if the detected voltage cannot be obtained, the process returns to step S2 via step S6, similarly to the case of FIG. 4. On the other hand, if the detected voltage can be obtained, the CPU 23a of the control section 23 determines whether or not the detected voltage is less than the threshold Vth which has been set corresponding to the characteristics which have been previously stored in the memory 24 and the like, based on the comparison, as shown in step S12.

Then if the detected voltage is less than the threshold Vth, the CPU 23a of the control section 23 controls to modify the value of the particular communication parameter to increase the detected voltage (in FIG. 6, the subscript of the particular communication parameter is denoted by i+p), as shown in step S13. Specifically, after the transmission output is increased and the like as described above, the process returns to step S2.

The control as described above enables to modify and set the communication parameter Ci so that the detected voltage suitable for the communication can be obtained, and to set the state of enabling the normal demodulation, in a shorter period of time and more smoothly than the case where the detected voltage is not monitored.

On the other hand, in the determination at step S12, if the detected voltage is equal to or more than the threshold Vth, the process returns to step S2 via step S6.

It should be noted that, in the description of the operation of FIG. 6, although whether or not the detected voltage is less than the threshold Vth (that is, whether or not the detected voltage is less than a value suitable for the communication) is determined at step S12, an operation of determining whether or not the detected voltage is too high may be further performed. Then, if the detected voltage is too high, a control of reducing the transmission output or reducing the Q value may be performed.

Other configurations and operations are similar to those of the first embodiment.

According to the present embodiment, the data on the characteristics in which the detected voltage is changed depending on the communication distance is used to enable smoother setting of the communicable state.

It should be noted that, although the example of monitoring the detected voltage and controlling to modify the particular communication parameter on the part of the R/W has been described in the present embodiment, in the case of a configuration in which the communication parameter can be modified also on the part of the RFID as will be described in the following third embodiment, the particular communication parameter on the part of the RFID may be modified, not only on the part of the R/W.

### Third Embodiment

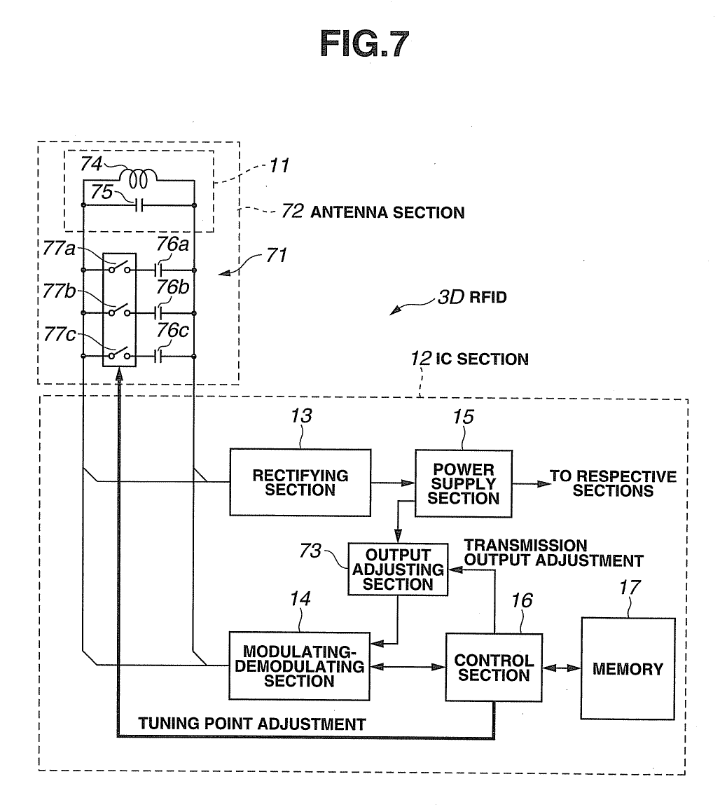

Next, the third embodiment of the present invention will be described. FIG. 7 shows an RFID 3D according to the third embodiment of the present invention. The present embodiment has a configuration in which the communication parameter of the RFID 3D can be modified (adjusted).

This RFID 3D has an antenna section 72 provided with a tuning point adjusting circuit 71 which can modify the tuning point of the antenna 11 in the RFID 3A of FIG. 2, and also has an output adjusting section 73 which can modify the transmission output in the case of transmission, in the IC section 12.

Then, depending on the command from the R/W 4, the control section 16 controls tuning point adjustment (or modification) in the tuning point adjusting circuit 71 and transmission output adjustment (or modification) in the output adjusting section 73.

The antenna section 72 has the antenna 11 consisting of a coil 74 and a condenser 75, and a condenser 76a and a switch 77a, a condenser 76b and a switch 77b, as well as a condenser 76c and a switch 77c are connected in parallel to this antenna 11.

ON/OFF of the switch 77k (k=a to c) is controlled according to a digital signal from the control section 16. This control adjusts the tuning point of the antenna 11.

Moreover, the output adjusting section 73 is configured with the variable resistor 62 of FIG. 3 and the like. The control section 16 can adjust a modulation output level in the transmission supplied from the power supply section 15 to the modulating-demodulating section 14, by controlling the resistance value of the variable resistor 62 with the digital signal.

Moreover, in the RFID communication system according to the present embodiment, the R/W 4, for example, the R/W 4 of FIG. 1, can transmit a tuning point adjusting command configured to adjust the tuning point, and a command configured to adjust the modulation output level in the transmission by the output adjusting section 73 (which is referred to as “transmission output adjusting command”), with respect to the RFID 3D.

The RFID 3D interprets other commands and also stores command information for interpreting these commands in the memory 17. When the signal is transmitted from the R/W 4, the control section 16 interprets the command from the transmitted signal via the modulating-demodulating section 14, and performs a control operation corresponding to the command (the tuning point adjustment or the transmission output adjustment).

In the first embodiment, the configuration in which the communication parameters can be modified has been provided only in the R/W 4, and the control section 23 has controlled to modify the communication parameters on the part of the R/W 4.

On the other hand, in the present embodiment, since the configuration in which the communication parameters can be modified is provided not only in the R/W 4 but also in the RFID 3D, the control section 23 and the control section 16 can control to modify the communication parameters on the part of the R/W 4 and the part of the RFID 3D.

Moreover, the control section 23 can control to modify the communication parameters on the part of the R/W 4, and also can control to modify the communication parameters on the part of the RFID 3D, via the control section 16.

It should be noted that, although the configuration example shown in FIG. 7 shows the configuration example in which the communication parameters of the tuning point and the transmission output can be modified, the configuration may be a configuration in which other communication parameters, for example, such as the Q value as shown in FIG. 3, can also be modified.

Other configurations are similar to those of the RFID 3A shown in FIG. 2. Next, the operation of the communication according to the present embodiment will be described. In this case, the operation in the case of using the R/W 4 shown in FIG. 1 and the RFID 3D will be described.

In the first and second embodiments, when the communication with the RFID 3I is performed, the control section 23 has controlled to modify and set the communication parameters on the part of the R/W 4. However, in the present embodiment as described below, the control section 23 will modify and set the communication parameters on the part of the R/W 4 and the part of the RFID 3D.

In this case, the control section 23 does not control to directly modify the communication parameters on the part of the RFID 3D, but will transmit a modification command to the RFID 3D and perform the modification via the control section 16 on the part of the RFID 3D.

In the above described embodiments, the example of modifying the communication parameter Ci on the part of the R/W 4 and performing the communication has been described. However, the present embodiment will be described with the communication parameters for the adjustment of the tuning point and the transmission output of the RFID 3D as Dj (j=1 to n).

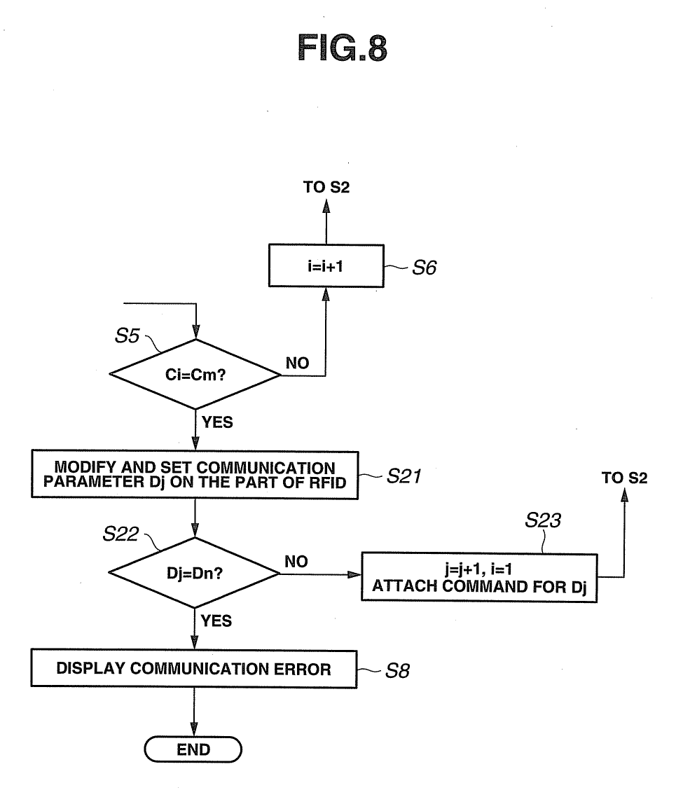

FIG. 8 shows a part of a flowchart of an example of the communication operation. The operation shown in FIG. 8 has the contents of the flowchart of FIG. 4 in which the process between step S5 to step S8 has been modified. In other words, the process similar to FIG. 4 is performed from step S1 to step S7.

Then, at step S5, it is determined whether or not the current communication parameter Ci is the last communication parameter Cm, and if it is determined that the current communication parameter Ci is not the last communication parameter Cm, the process proceeds to step S6.

On the other hand, if it is determined that the current communication parameter Ci is the last communication parameter Cm, the process proceeds to step S21, where the CPU 23a of the control section 23 starts the control of modifying and setting the communication parameter Dj on the part of the RFID 3D, for example, from the previously set value.

Specifically, if it is assumed that the communication parameter Dj on the part of the RFID 3D is a communication parameter D1 having a previously set initial value, the CPU 23a modifies the communication parameters sequentially from the communication parameter D1 as described below.

At the next step S22, the CPU 23a determines whether or not the current communication parameter Dj (the initial value is j=1) is a last communication parameter Dn, and if the current communication parameter Dj does not correspond to the last communication parameter Dn, j=j+1 and i=1 are set and the command to be set to this communication parameter Dj is attached at step S23, and the process returns to step S2.

In this case, the reply request signal will be transmitted from the R/W 4 to the RFID 3D, in a state where the modification command has been attached to the communication parameter Dj.

It should be noted that since i=1 is set at step S23, in a state where the communication parameter Dj on the part of the RFID 3D has been modified, the R/W 4 will modify and set the communication parameter Ci cyclicly from its initial value again to monitor the state of receiving the signal replied from the RFID 3D.

If the signal attached with the communication parameter Dj is transmitted and the RFID 3D normally demodulates this signal, the control section 16 interprets the attached command and controls to modify the communication parameter Dj as instructed in the command.

For example, if the attached command is for increasing the transmission output, the control section 16 controls the output adjusting section 73 to increase the transmission output. In this way, the communication characteristics on the part of the RFID 3D are modified, and the R/W 4 determines whether or not the signal from the RFID 3D can be normally demodulated.

Then, if the normally demodulated signal cannot be obtained even when the CPU 23a of the control section 23 controls to modify the communication parameters until the last communication parameter Dn with respect to the RFID 3D, the process proceeds to step S8 where the communication error is displayed, and the process is terminated.

By performing this operation, for example, also in the case where the communication error is caused in the first embodiment, the communication parameters on the parts of the RFID 3D are further modified and the communication operation is performed in the present embodiment. Therefore, the communicable state can be automatically set more certainly.

It should be noted that, in the operation example of FIG. 8, although the example has been described in which the communication parameter Dj is sequentially modified and the modification and the setting are performed until the last communication parameter Dn, only some communication parameters may be modified.

For example, in a state of a communication parameter D2 next to the communication parameter D1 having the initial value, the transmission output adjusting command is attached so as to adjust the transmission output to be maximum and transmitted to the RFID 3D. Then, if the demodulation has not been able to be normally performed in this state, the communication parameter of the tuning point may be modified so that the tuning point of a different kind on the part of the RFID 3D is adjusted (without modifying the communication parameter of the transmission output).

It should be noted that, for example, in the R/W 4 according to the first embodiment and the like, the antenna section 21 or the antenna 43 may be configured with multiple antennas having different tuning points respectively, and a control of switching the antenna to be used may be performed by the control section 23. Moreover, a configuration of switching the multiple antennas may be provided for also accommodating the case of the wireless communication having significantly different frequency bands.

Moreover, for example, in the R/W 4, the antenna section 21 and the modulating-demodulating section 22 (or a transmitting-receiving section) configured to perform the transmission and the receiving, for example, may not be configured to use the common antenna, but may be configured to use separate antennas in the transmission and in the receiving.

Moreover, in the above description, the case has been described in which the communication operation is started by the user inputting the instruction to perform the communication with respect to the RFID 3I or the RFID 3D to be communicated with, from the instruction inputting section 25, on the part of the R/W 4.

The present invention is not limited thereto, and for example, the R/W 4 may be set so that the communication operation can be constantly performed, and the communication operation may be performed with the RFID 3I and the like with which the user hopes to perform read/write, at an almost arbitrary timing. In this case, the above described control operation may be partially modified.

For example, if this is described in the case of the RFID communication system 1 of FIG. 1, a trigger of the instruction for the communication is automatically generated at step S1 after the start, and the process proceeds to step S2, in FIG. 4. Then, the process from step S2 to step S8 is similarly performed. Moreover, in the case of the end (termination), the process returns to step S1, and then the trigger of the instruction for the communication is generated as described above and the process proceeds to step S2.

In this way, the process of FIG. 4 is constantly repeated in a short interval. Accordingly, if the user or the like brings the RFID 3I with which the user or the like hopes to perform the read/write, close to the R/W 4, at the almost arbitrary timing, the state where the communication can be performed with the RFID 3I can be automatically set, almost similarly to the description in the first embodiment.

However, this case is different from the operation of the first embodiment in that, although the process of modifying the communication parameter Ci is repeated from C1 to Cm, the set value of the communication parameter Ci of the R/W 4 is different from a condition of starting from the initial value 1, depending on the timing when the RFID 3I has been actually brought close to the R/W 4.

Moreover, if the time in which the user or the like brings the RFID 3I with which the user or the like hopes to perform the read/write, close to the R/W 4 to cause the R/W 4 to perform the read/write is limited, the number, the kind or the like of the communication parameter Ci to be modified may be limited, or a range of the communication parameter to be modified may be limited with reference to information in the case where the read/write have been able to be performed.

It should be noted that, although, for example, the second embodiment has been described in the case where the level of the detected voltage has been monitored, the present invention is not limited thereto, and for example, the case where the CPU 23a controls to modify the particular communication parameter (in preference to the modification of the normal communication parameter) depending on a degree of demodulation of demodulated data demodulated by (the demodulating section of) the modulating-demodulating section 22, also belongs to the present invention.

For example, instead of monitoring the level of the detected voltage, whether or not the demodulated data has been obtained may be monitored, and if the demodulated data has been actually obtained, an error rate with respect to code of the demodulated data with respect to the case where the demodulation has been normally performed may be examined, and if the error rate is higher than a previously set reference value, the control of modifying the particular communication parameter may be performed such as increasing the transmission output on the part of the R/W 4.

In the description of the above embodiments, the R/W 4 sets the communication parameters affecting the communication characteristics, and if the R/W 4 performs the transmission to the RFID with the communication parameters, the R/W 4 monitors the state of receiving the signal replied from the RFID, and depending on a result of determining the receiving state, the R/W 4 controls to modify, or not to modify, the state of the current communication parameters.

If the receiving state is determined, the determination is not limited to the case of the set value of one communication parameter, but may be performed with respect to the set values of the multiple communication parameters. If this is described in a specific example, the R/W 4 may first set the communication parameters to C1, C2 and C3 sequentially, transmit the reply request signals sequentially, and monitor the states of receiving the signals replied from the RFID 3I.

Then, for example, if it is determined that the receiving state is a state where the signal cannot be completely received, the R/W 4 may set the communication parameters to C4, C5 and C6 sequentially, transmit the reply request signals sequentially, and monitor the states of receiving the signals replied from the RFID 3I. Such a communication method and the like also belong to the present invention.

It should be noted that embodiments, in which the above described respective embodiments are partially combined or transformed, also belong to the present invention.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An RFID (Radio Frequency Identification) communication system comprising:
a communication parameter setting section configured to modifiably set communication parameters related to communication characteristics in performing wireless communication;
a receiving state determining section configured to, in the case where a signal for causing an RFID provided with a wireless communication function to wirelessly reply has been wirelessly transmitted with respect to said RFID by using previously set communication parameters, determine a state of receiving a reply signal wirelessly replied from said RFID; and
a control section configured to, if a determination result by said receiving state determining section does not satisfy a predetermined condition, control to modify the communication parameters modifiable by said communication parameter setting section.

2. The RFID communication system according to claim 1, wherein:
if said determination result does not satisfy said predetermined condition as a receiving state where said reply signal can be normally received, said control section controls to modify the communication parameters modifiable by said communication parameter setting section, and also controls to cause said RFID provided with said wireless communication function and an RFID communication device provided with a wireless communication function configured to perform the wireless communication with said RFID, to perform the wireless communication with the modified communication parameters.

3. The RFID communication system according to claim 1, wherein:
said control section further controls to modify a particular communication parameter in multiple kinds of parameters modifiable by said communication parameter setting section, depending on a result of determining a detection level when said reply signal is received.

4. The RFID communication system according to claim 3, wherein:
if the determination result is that the detection level when said reply signal is received is less than or equal to a predetermined value, said control section modifies the particular communication parameter to increase one of transmission power and a detection output.

5. The RFID communication system according to claim 1, wherein:
said control section modifies said communication parameters in an RFID communication device provided with a wireless communication function configured to perform the wireless communication with said RFID.

6. The RFID communication system according to claim 1, wherein:
said communication parameter setting section can modify one or more kinds of communication parameters from multiple kinds of communication parameters including a modulation method, a degree of modulation, a tuning frequency, a Q value, and a transmission output.

7. The RFID communication system according to claim 6, wherein:
said communication parameter setting section is provided in an RFID communication device provided with a wireless communication section configured to perform the wireless communication with said RFID.

8. The RFID communication system according to claim 6, wherein:
said communication parameter setting section is provided in said RFID.

9. The RFID communication system according to claim 1, wherein:
if the result of determining the receiving state by said receiving state determining section has satisfied the predetermined condition, communication parameters corresponding to the case of satisfying said predetermined condition are maintained and also information on said communication parameters is stored in a storing section.

10. An RFID communication device comprising:
a wireless communication section configured to perform wireless communication with an RFID provided with a wireless communication function;
a communication parameter setting section configured to modifiably set communication parameters related to communication characteristics in performing the wireless communication by said wireless communication section;
a receiving state determining section configured to wirelessly transmit a signal for causing said RFID to wirelessly reply, from said wireless communication section, and determine a state of receiving a reply signal wirelessly replied from said RFID; and
a control section configured to, if a result of determining the receiving state by said receiving state determining section does not satisfy a predetermined condition, control to modify the communication parameters used for said wireless transmission and perform said wireless transmission.

11. The RFID communication device according to claim 10, wherein:
said communication parameter setting section can modify one or more kinds of communication parameters from multiple kinds of communication parameters including a modulation method, a degree of modulation, a tuning frequency, a Q value, and a transmission output.

12. The RFID communication device according to claim 10, wherein:
said control section controls to modify a particular communication parameter in multiple kinds of parameters modifiable by said communication parameter setting section, depending on a detection level when said reply signal is received.

13. The RFID communication device according to claim 10, wherein:
said control section is provided with a control function configured to modify the communication parameters of said RFID.

14. The RFID communication device according to claim 10, comprising:
a storing section configured to, if the result of determining the receiving state by said receiving state determining section satisfies a predetermined condition in which said reply signal can be normally received, store information on the communication parameters used for said wireless transmission in the case where said predetermined condition is satisfied.

15. The RFID communication device according to claim 10, wherein:
said control section has a control program storing section storing a control program configured to perform said control corresponding to the result of determining the receiving state by said receiving state determining section.

16. The RFID communication device according to claim 10, wherein:
if the result of determining the receiving state by said receiving state determining section does not satisfy the predetermined condition, said control section repeatedly performs a control of sequentially modifying the communication parameters used for said wireless transmission so as to be different from the communication parameters used in the past and performing said wireless transmission, until the communication parameters in the case where the result of determining the receiving state by said receiving state determining section satisfies said predetermined condition in which said reply signal can be normally received are set.

17. An RFID communication method comprising:
in the case where a signal for causing an RFID provided with a wireless communication function to wirelessly reply has been wirelessly transmitted with respect to said RFID by using previously set communication parameters related to communication characteristics, determining a state of receiving a reply signal wirelessly replied from said RFID; and
if a result of determining said receiving state does not satisfy a predetermined condition, controlling to modify said communication parameters and perform the wireless transmission.

18. The RFID communication method according to claim 17, comprising:
if the result of determining said receiving state does not satisfy said predetermined condition, modifying the communication parameters of an RFID communication device configured to perform wireless communication with said RFID.

19. The RFID communication method according to claim 17, comprising:
if the result of determining said receiving state does not satisfy said predetermined condition, modifying the communication parameters of said RFID.

20. The RFID communication method according to claim 17, comprising:
if the result of determining said receiving state satisfies said predetermined condition in which said reply signal can be normally received, maintaining said communication parameters and performing the wireless transmission.
